(19) United States
(12) Patent Application Publication
(10) Pub. No.: US 2024/0412098 A1
(43) Pub. Date: Dec. 12, 2024

(54) SYNTHESIZING REALISTIC TIME SERIES WITH OUTLIERS

(71) Applicant: Visa International Service Association, San Francisco, CA (US)

(72) Inventors: Hanqing Chao, Troy, NY (US); Yuhang Wu, Santa Clara, CA (US); Xiaoting Li, Sunnyvale, CA (US); Hongyi Liu, Buda, TX (US); Kwei-Herng Lai, Houston, TX (US); Linyun He, Austin, TX (US); Shubham Agrawal, Round Rock, TX (US); Mahashweta Das, Campbell, CA (US); Hao Yang, San Jose, CA (US)

(73) Assignee: Visa International Service Association, San Francisco, CA (US)

(21) Appl. No.: 18/330,122

(22) Filed: Jun. 6, 2023

(51) Int. Cl. G06N 20/00; G06F 17/14

(52) U.S. Cl. CPC G06N 20/00; G06F 17/141

(57) ABSTRACT

Methods and systems are provided for synthesizing realistic time series data that may be used to better identify outliers within the synthesized realistic time series data. Noise can be introduced to a time domain representation of time series data and can introduce noise to a frequency domain representation of the time series data. Further, labeled anomalous points can be inserted into the time series data. The time series data may then be used for training a machine learning model to identify anomalies within new time series data.

### BACKGROUND

Machine learning models generally rely on training data that is used to train the model for use with new data. Existing training data sets are limited because they are restricted to the amount of available data, do not contain a diverse set of realistic outliers, and/or require significant human labor to label the data (e.g., labeling where anomalous points are located within the data and what type of anomaly exists at the respective point(s)). Further, existing methods of synthesizing training data for time series sequences only generate simple sequences without much complexity (e.g., relatively smooth sine waves, relatively smooth square waves). Such simplistic data generation is problematic because it is not representative of real-life data sequences and the anomalies that may be found therein.

Time series outlier detection techniques have been applied in various scenarios. However, lifelike time series data capable of having diverse types of time series outliers is lacking. Many existing time series datasets do not contain all types of outliers and/or do not provide labeled data (e.g., anomaly location and anomaly type labels). If a real-world time series dataset was used to train a machine learning model, excessive human labor would be required to create labels for data points. Further, existing synthesizing methods only generate simple sequences (e.g., sine waves and square waves) that are very different from the real-life data. Thus, the lack of realistic time series data to be used for training a machine learning model create challenges in correctly detecting outliers.

Embodiments of the disclosure address these problems and other problems individually and collectively.

### SUMMARY

Embodiments are directed to methods and systems for synthesizing realistic time series data that may be used to better identify outliers within the synthesized realistic time series data. Various embodiments can introduce noise to a time domain representation of time series data and can introduce noise to a frequency domain representation of the time series data. Further, embodiments can insert labeled anomalous points into the time series data. The time series data may then be used for training a machine learning model to identify anomalies within new time series data.

One embodiment can include a method of training a machine learning model, the method can include receiving time series data for training the machine learning model and generating a base frequency domain representation of the time series data. The method can further include adding a first noise to the base frequency domain representation to obtain a noisy frequency domain representation, obtaining a first noisy time domain representation of the time series data by applying an inverse discrete Fourier transform to the noisy frequency domain representation, the first noisy time domain representation including a set of values for a set of time points, wherein each value in the set of values corresponds to a time point in the set of time points. Additionally, the method can include adding a second noise to one or more values in the set of values of the first noisy time domain representation of the time series data to generate a second noisy time domain representation, for each of one or more time points in the second noisy time domain representation, replacing the corresponding value with an anomalous value, to generate an anomalous training data set including one or more anomalous values, the anomalous training data set having a corresponding anomalous label for a time period including the one or more anomalous values, and training the machine learning model using the anomalous training data set and the corresponding anomalous label.

These and other embodiments are described in further detail below. For example, other embodiments are directed to systems, devices, and computer readable media associated with methods described herein.

### TERMS

A “server computer” may include a powerful computer or cluster of computers. For example, the server computer can include a large mainframe, a minicomputer cluster, or a group of servers functioning as a unit. In one example, a server computer can include a database server coupled to a web server. The server computer may comprise one or more computational apparatuses and may use any of a variety of computing structures, arrangements, and compilations for servicing the requests for one or more “client computers.”

A “memory” may include any suitable device or devices that may store electronic data. A suitable memory may comprise a non-transitory computer readable medium that stores instructions that can be executed by a processor to implement a desired method. Examples of memories include one or more memory chips, disk drives, etc. Such memories may operate using any suitable electrical, optical, and/or magnetic mode of operation.

A “processor” may include any suitable data computation device or devices. A processor may comprise one or more microprocessors working together to accomplish a desired function. The processor may include a CPU that comprises at least one high-speed data processor adequate to execute program components for executing user and/or system generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xenon, and/or Xscale; and/or the like processor(s).

“Time series data” may refer to values of a data parameter that occurs over time. For example, a data parameter may be a number of requests to a given server per unit time, e.g., per 1, 5, or 10 minute intervals. Such parameter values can be obtained from raw data that occurs in real-time.

“Noise” may be a random variation or fluctuation that interferes with a base signal. Noise can be added to a base signal by adding or subtracting random values at one or more data points, e.g., in time series data. In one example, a base signal may be a sine wave and once noise is added to it, the sine wave is no longer smooth.

A “uniform distribution” may refer to a probability distribution (e.g., probability density function or probability mass function) where possible values associated with a random variable are equally possible. A fair dice is an example of a system corresponding to a uniform distribution (in that the probability of any two rolls are equal). The term “non-uniform distribution” may refer to a probability distribution where all possible values or intervals are not equally possible. A Gaussian distribution is an example of a non-uniform distribution.

“Classification” may refer to a process by which something (such as a data value, feature vector, etc.) is associated with a particular class of things. For example, an image can be classified as being an image of a dog. “Anomaly detection” can refer to a classification process by which something is classified as being normal or an anomaly. An “anomaly” may refer to something that is unusual, infrequently observed, or undesirable. For example, in the context of email communications, a spam email may be considered an anomaly, while a non-spam email may be considered normal. Classification and anomaly detection can be carried out using a machine learning model.

The term “artificial intelligence model” or “machine learning model” can include a model that may be used to predict outcomes to achieve a pre-defined goal. A machine learning model may be developed using a learning process, in which training data is classified based on known or inferred patterns.

“Machine learning” can include an artificial intelligence process in which software applications may be trained to make accurate predictions through learning. The predictions can be generated by applying input data to a predictive model formed from performing statistical analyses on aggregated data. A model can be trained using training data, such that the model may be used to make accurate predictions. The prediction can be, for example, a classification of an image (e.g., identifying images of cats on the Internet) or as another example, a recommendation (e.g., a movie that a user may like or a restaurant that a consumer might enjoy).

A “machine learning model” may include an application of artificial intelligence that provides systems with the ability to automatically learn and improve from experience without explicitly being programmed. A machine learning model may include a set of software routines and parameters that can predict an output of a process (e.g., identification of an attacker of a computer network, authentication of a computer, a suitable recommendation based on a user search query, etc.) based on feature vectors or other input data. A structure of the software routines (e.g., number of subroutines and the relation between them) and/or the values of the parameters can be determined in a training process, which can use actual results of the process that is being modeled, e.g., the identification of different classes of input data. Examples of machine learning models include support vector machines (SVM), models that classify data by establishing a gap or boundary between inputs of different classifications, as well as neural networks, collections of artificial “neurons” that perform functions by activating in response to inputs. A machine learning model can be trained using “training data” (e.g., to identify patterns in the training data) and then apply this training when it is used for its intended purpose. A machine learning model may be defined by “model parameters,” which can comprise numerical values that define how the machine learning model performs its function. Training a machine learning model can comprise an iterative process used to determine a set of model parameters that achieve the best performance for the model.

A “resource” generally refers to any asset that may be used or consumed. For example, the resource may be computer resource (e.g., stored data or a networked computer account), a physical resource (e.g., a tangible object or a physical location), or other electronic resource or communication between computers (e.g., a communication signal corresponding to an account for performing a transaction). Some non-limiting examples of a resource may include a good or service, a physical building, a computer account or file, or a payment account. In some embodiments, a resource may refer to a financial product, such as a loan or line of credit. An “electronic resource” may be a resource that is accessed via electronic means. For example, an electronic resource may be a computer, which has an account to accessed with or for a user device. The account may be a financial account, an email account, etc. The electronic resource may require a secret, such as a password or cryptographic key, to access.

The term “access request” generally refers to a request to access a resource. The access request may be received from a requesting computer, a user device, or a resource computer, for example. The access request may include authorization information, such as a username, account number, or password. The access request may also include and access request parameters, such as an access request identifier, a resource identifier, a timestamp, a date, a device or computer identifier, a geo-location, or any other suitable information. The access requests can be received in real time.

### BRIEF DESCRIPTION OF THE DRAWINGS

FIG. 1 illustrates a method of training a machine learning model to identify anomalies.

FIG. 2 illustrates a method of generating anomalous data for training a machine learning model.

FIG. 3 illustrates an example of how a time domain spectrum may be transformed into a frequency domain spectrum, given numbers in the time domain spectrum and using a discrete Fourier Transform (FFT).

FIG. 4 illustrates an example of transforming a frequency domain spectrum into a time domain spectrum, given numbers in the frequency domain spectrum and using an inverse discrete Fourier Transform (IFFT).

FIG. 5A illustrates an example of a global point outlier. FIG. 5B illustrates an example of a contextual point outlier. FIG. 5C illustrates an example of a shapelet outlier. FIG. 5D illustrates an example of a seasonal outlier. FIG. 5E illustrates an example of a trend outlier.

FIG. 6 illustrates a method for generating noisy training data according to an embodiment of the present disclosure.

FIG. 7 illustrates a method for generating anomalous points and corresponding labels within a time series, according to an embodiment of the present disclosure.

FIG. 8 illustrates a method for generating noisy data, anomalous points, and corresponding labels within a time series to create a noisy and anomalous training dataset, according to an embodiment of the present disclosure.

FIG. 9 illustrates an example of datasets created using an embodiment of the present disclosure.

FIG. 10 illustrates a computer system that may be used with embodiments of the present disclosure.

### DETAILED DESCRIPTION

Embodiments include methods and systems for generating noisy time series data. Time series data may refer to any collection data values that correspond to a period of time. The generated noisy time series data may include various types of anomalous data points. Further, all data points in the generated noisy time series can be labeled during generation of the noisy time series for use in training a machine learning model. The labeling can specify anomalous points are located within the data and what type of anomaly exists at the respective point(s).

As an example, embodiments can add noise to a base signal within the frequency domain and within the spatial/time domain. By adding noise to each of a time domain of the base signal and the frequency domain of the base signal, a complex base signal may be generated. Such a complex (e.g., not as relatively smooth) base signal may allow for further type of anomalies to be inserted into the signal.

A challenge of generating anomalous data points by adding them to a base signal is to retain and control the original patterns of the base signal. Noise and anomalies that are added to the base pattern can break the patterns (e.g., period, shape, value range) of the base signals. To retain the original base signal patterns, the base signal can have a consistent pattern over time and may contain noises that do not break the patterns.

Solutions described herein can generate a complex and/or realistic time series where the position and anomaly type of each anomaly is known while also retaining the base signal pattern. Such complex time series data that includes anomalies may be useful for training models to detect anomalies in future unlabeled time series. Anomalies may be anomalous access requests to a resource. For example, anomalies may relate to cybersecurity for a networked computer, where such time series data relates to data read operations, data write operations, communications from/to a device, communications between devices, etc. Thus, precise anomaly detection may be useful in many scenarios.

### I. Training and Use of a Model to Detect Anomalies

Anomalous datapoints may exist in a time series dataset. For example, one datapoint may have a value 90% larger than any other datapoint in the time series and therefore be classified as an anomalous value within the time series dataset. A machine learning model may be trained and subsequently used to identify such an anomaly. Labeled time series data may be used to train the machine learning model to detect anomalous data points within given time series data.

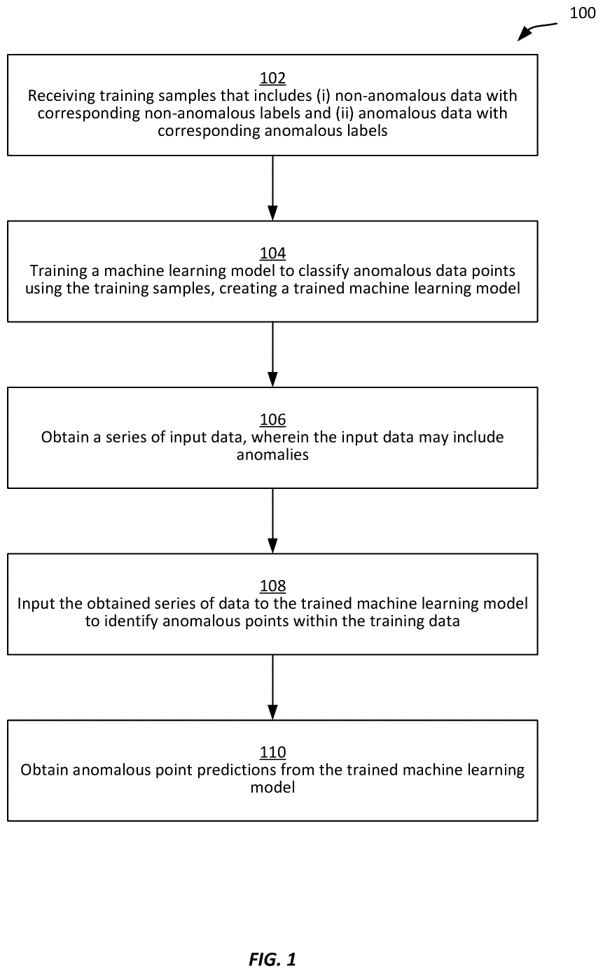

FIG. 1 illustrates a method 100 of training and using a machine learning model to identify anomalies in time series data. Method 100 can be performed by one or more processors of a computer system.

At step 102, training samples are received. The training samples can include (i) non-anomalous data with corresponding non-anomalous labels and (ii) anomalous data with corresponding anomalous labels. For example, one set of time series data can include a label indicating that no anomalies are present or that one or more segments do not have anomalies. The anomalous data can have one or more segments that are labeled as including an anomaly, and potentially a particular type of anomaly. The training samples received may be obtained from a previously obtained time series dataset that was manually labeled with labels indicating anomalous and non-anomalous datapoints.

At step 104, a machine learning model is trained to classify anomalous data points using the training samples received in step 102 to create a trained machine learning model. The trained machine learning model will then be able to receive input time series and generate predictions as to which points from the received input time series are anomalous.

In broad terms, the process of training a machine learning model can involve determining the set of parameters that achieve the “best” performance, often based on the output of a loss or error function. A loss function typically relates the expected or ideal performance of a machine learning model to its actual performance. For example, if there is a training data set comprising input data paired with corresponding labels (indicating, e.g., whether that input data corresponds to normal data or anomalous data), then a loss function or error function can relate or compare the classifications or labels produced by the machine learning model to the known labels corresponding to the training data set. If the machine learning model produces labels that are identical to the labels associated with the training data, then the loss function may take on a small value (e.g., zero), while if the machine learning model produces labels that are totally inconsistent with the labels corresponding to the training data set, then the loss function may take on a larger value (e.g., one, a value greater than one, infinity, etc.).

In some cases, the training process can involve iteratively updating the model parameters during training rounds, batches, epochs, or other suitable divisions of the training process. In each round, a computer system can evaluate the current performance of the model for a particular set of parameters using the loss or error function. Then, the computer system can use metrics such as the gradient and techniques such as stochastic gradient descent to update the model parameters based on the loss or error function. In summary terms, the computer system can predict which change to the model parameters result in the fastest decrease in the loss function, then change the model parameters based on that prediction. This process can be repeated in subsequent training rounds, epochs, etc. The computer system can perform this iterative process until training is complete. In some cases, the training process involve a set number of training rounds or epochs. In other cases, training can proceed until the model “converges”, i.e., the model shows little to no further improvement in successive training rounds, or that the difference in the output of the error or loss function between successive training rounds approaches zero.

Once training has been completed, a trained classifier can be used to classify unlabeled input data based on the parameters determined during training. In the context of embodiments, data features corresponding to a time series can be input into a trained classifier, which can then return a classification or label, e.g., “normal” or “anomalous.” Optionally, a classifier can return a value that corresponds to the classifier's confidence in its classification. A classification such as “normal 0.95” could indicate that the classifier classifies the time series as normal with 95% confidence. Alternatively, numeric output values can indicate both the classifier's classification and its confidence. For example, if the value 0 corresponds to a normal classification, and the value 1 corresponds to an anomalous classification, then an output classification such as 0.01 could indicate high (but not complete) confidence that a time gap is normal, while a classification such as 0.5 could indicate classification ambiguity between a normal time gap and an anomalous time gap.

At step 106, a series of input data is obtained. The input data may include anomalies. The series of input data may be obtained by collecting the data (e.g., from prior observed spatial time series data, from a previous anomalous training data set) or generating it (e.g., sinusoidal (sine) wave, square wave, triangular wave, sawtooth wave). The input data may then be used with the trained machine learning model, in step 108, to identify anomalous points within the training data.

At step 110, the machine learning model may provide the anomalous point predictions from the trained machine learning model. The trained machine learning model may predict whether a time series includes at least one anomaly, how many anomalies are in a time series, what type of anomalies appear in a time series, a probability that each respective point is an anomaly. Additionally, the trained machine learning model may output a confidence value for any of these example outputs. The anomalous point predictions may not always be correct because the predictions are made by the trained model based on the training data that was used to train the trained machine learning model. Thus, increasing the amount of training data may allow for the trained model to generate more correct predictions.

As seen above because training a machine learning model to detect anomalous data points within a given time series requires the use of labeled training data, there is a need for the ability to produce time series data with labeled anomalies that may be used to train such a model.

### II. Generating Anomalous Training Data

As alluded to in the previous section, there exists a need for the ability to produce time series data with labeled anomalies that may be used to train a machine learning model to identify anomalies within given time series data. Thus, a method for producing time series data with labeled anomalies may include receiving time series data, inserting anomalies into the data and keeping track of where the anomalies are with labels, and using the labeled and anomalous data to train a machine learning model. A method of generating anomalous data for training a machine learning model is described in more detail below.

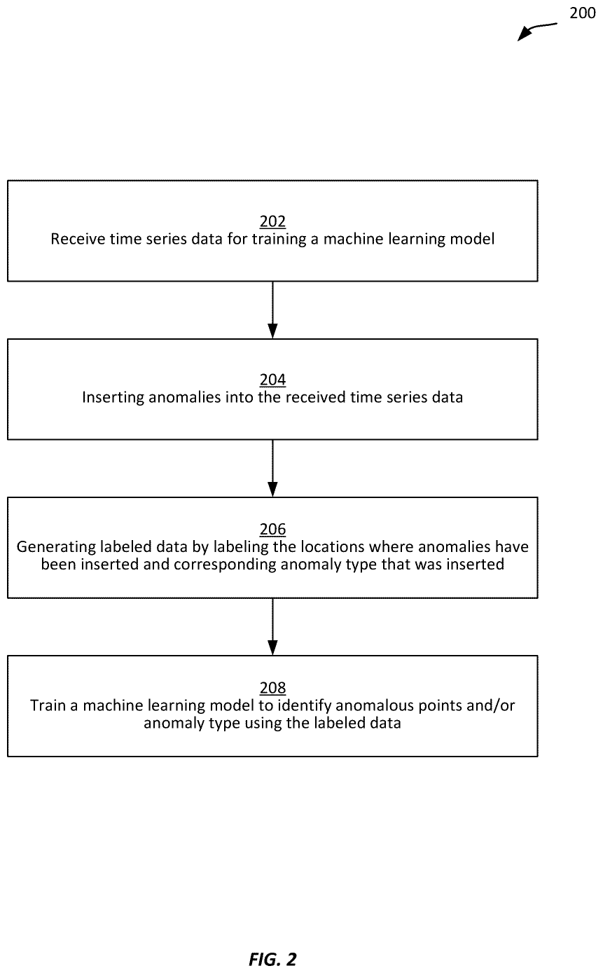

FIG. 2 illustrates a method 200 of generating anomalous data for training a machine learning model.

At step 202, time series data is received for training a machine learning model. The time series data may be received after the time series data has been collected. For example, the time series data can be collected from prior observed spatial time series data and/or from a previous anomalous training data set. Additionally, or alternatively the time series data can be generated. For example, the time series data may be generated using a sinusoidal (sine) wave, square wave, triangular wave, sawtooth wave, or another periodic waveform. A discrete Fourier Transform can be used with a periodic signal. A periodic signal repeats a sequence of values after a fixed length of time (a period of the signal).

At step, 204, anomalies may be inserted into the received time series data. As an example, the type of anomalies that could be inserted into the time series data may be a global point anomaly/outlier, a contextual point anomaly, a shapelet anomaly, and/or a trend anomaly. When anomalies are inserted into the time series data, if the positions of where the anomalies have been inserted into the time series data and the type of inserted anomaly is kept track of, labels may be created that correspond to the anomalous and non-anomalous data points of the time series in step 206. As an example of a label, the label may include information stating that an anomaly is located at a particular time position or may include information stating that the anomaly is located at the particular time position and has a first value. Some anomalies may have labels that correspond to a range of time positions (e.g., the anomaly corresponds to time positions two through seven).

In step 208, the labeled time series data (dataset with anomalous values and/or non-anomalous values) may then be used to train a machine learning model to identify anomalous points and/or types of anomalies within a given time series dataset.

Although method 200 gives an idea of how to generate anomalies within a time series so that the time series data and corresponding labels may be used for training a machine learning model, time series that would then be including anomalies may still be relatively smooth, and therefore not representative of realistic and/or complex time series data which may include anomalies therein. Thus, method 200 may be augmented to first generate noisy time series data from the time series data before the anomalous points are inserted into the noisy time series. Embodiments described herein include methods and systems for generating noisy time series data that may include various types of anomalous data points and corresponding labels. Embodiments described herein utilize a spatial/time domain representation of time series data and a frequency domain representation of time series data to generate time series data, add noise to time series data, and add anomalies to time series data to thereby synthesize realistic time series data. The relationship between a time/spatial domain representation of data and a frequency domain representation of data is described below.

### III. Time and Frequency Domain Representations

A time series can be represented in a time domain (also referred to as a spatial domain) and is also can be represented in the frequency domain (also referred to as a frequency spectrum). The representation of each of the two domains can more easily reflect respective characteristics of the time series.

A time domain graph can show how a signal changes with time. Representing a time series in the time domain is a common way that a time series is viewed (e.g., login attempts per minute, access events per day, transactions per second, etc.) and understood by humans. In the time domain, time is usually along the x-axis and another metric (e.g., login attempts, access events, transactions, etc.) is along the y-axis.

A frequency domain refers to the analytic space in which mathematical functions or signals are conveyed in terms of frequency, rather than time. Thus, a frequency-domain graph displays how much of a signal is present among each given frequency band.

By representing a time series in the frequency domain, the shape of a signal and character of a signal may be better understood. Each of the amplitude and the phase are a type of domain and provide different features for understanding the time series from different angles. A phase of a time series provides a measurement of where a time series wave is positioned within its cycle. As an example, phase may be represented in degrees (0-360 degrees) or radians (0-27). Thus, a phase of a wave is the position of the wave at a point in time on a waveform cycle. An amplitude of a time series is the magnitude of a wave signal in the time domain. Thus, the amplitude and the phase can capture the complexity of a pattern in the corresponding time domain of a time series.

A frequency domain spectrum may can represent a time series as a frequency-domain graph where the amplitude is on the y-axis and the frequency bands are on the x-axis. Further, a frequency domain spectrum can represent a time series as a frequency-domain graph where the phase is on the y-axis and the frequency bands are on the x-axis.

Due to the relationship that implicitly exists between a time domain representation and a frequency domain representation of a time series. Equations may be used to convert a time domain representation into a frequency domain representation, and vice-versa.

### A. Conversion of Time Domain to Frequency Domain

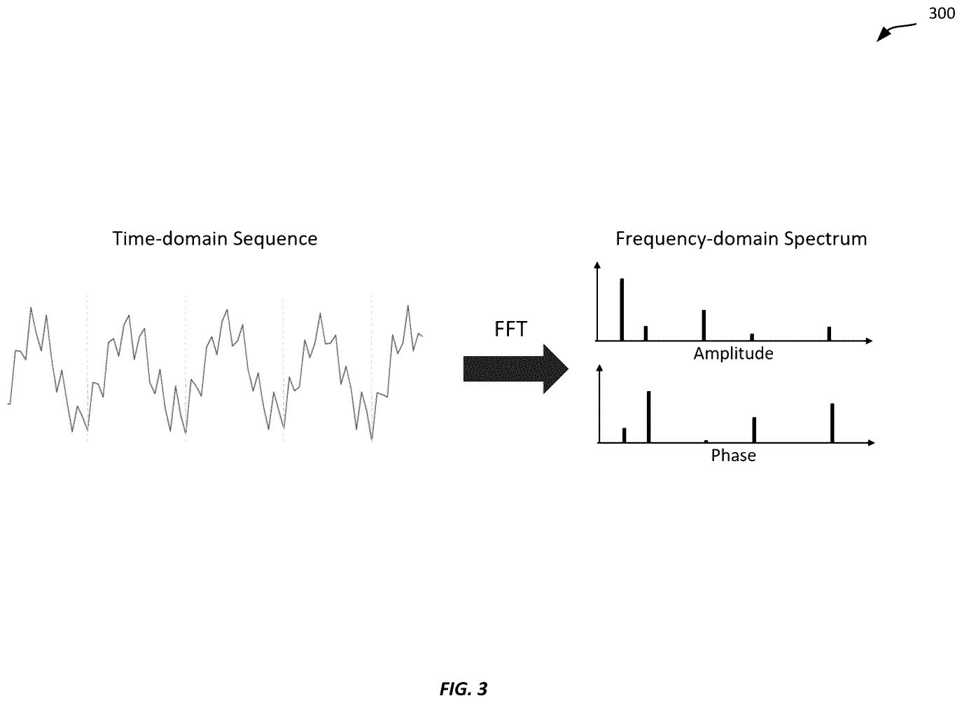

FIG. 3 illustrates an example of a transforming a time domain spectrum into a frequency domain spectrum, given numbers in the time domain spectrum and using a discrete Fourier Transform (FFT).

Illustration 300 shows that a time-domain sequence may be converted into a frequency-domain spectrum so that amplitude and/or phase may be visualized on a chart where the frequency bands make up the x-axis.

A time-domain representation of a sequence may be transformed into a frequency domain spectrum using a discrete Fourier transform. The discrete Fourier transform is mathematically defined as:

$${X}_{k} = {\sum }_{n = 0}^{N - 1} {x}_{n} \cdot {e}^{\frac{- i 2 π kn}{N}}$$

$${X}_{k} = {\sum }_{n = 0}^{N - 1} {x}_{n} \cdot ( cos \frac{2 π kn}{N} - i \cdot sin \frac{2 π kn}{N} )$$

A frequency domain spectrum of the time series is obtained by using the discrete Fourier transform (FFT). The frequency domain spectrum may include some important features of the time series (e.g., amplitude and phase).

As another example in addition to the time series example shown in illustration 300, an image may be represented in the time domain so that human eyes are able to visually perceive the image. However, an image can also be transformed into a frequency domain representation to obtain the corresponding amplitudes, phased, and other features of the image through a frequency domain representation of the image. Without representing the phase, amplitude, and/or any other values in the frequency domain representation a human eye is not as easily able to perceive such attributes of the image. The phase, amplitude, and/or any other features of the frequency domain representation can convey values relating to color, reclamation, resolution of the image, etc.

Thus, the frequency domain spectrum can disentangle different components of a time domain representation of a time series sequence, allowing the frequency domain spectrum to better depict data properties (e.g., wave position). As such, it would be possible to change characteristics of the time domain representation of a time series by altering the frequency domain representation values (e.g., by changing the amplitude and the phase for different coefficients in the frequency domain, the period of a wave in the time domain may be changed).

### B. Conversion of Frequency Domain to Time Domain

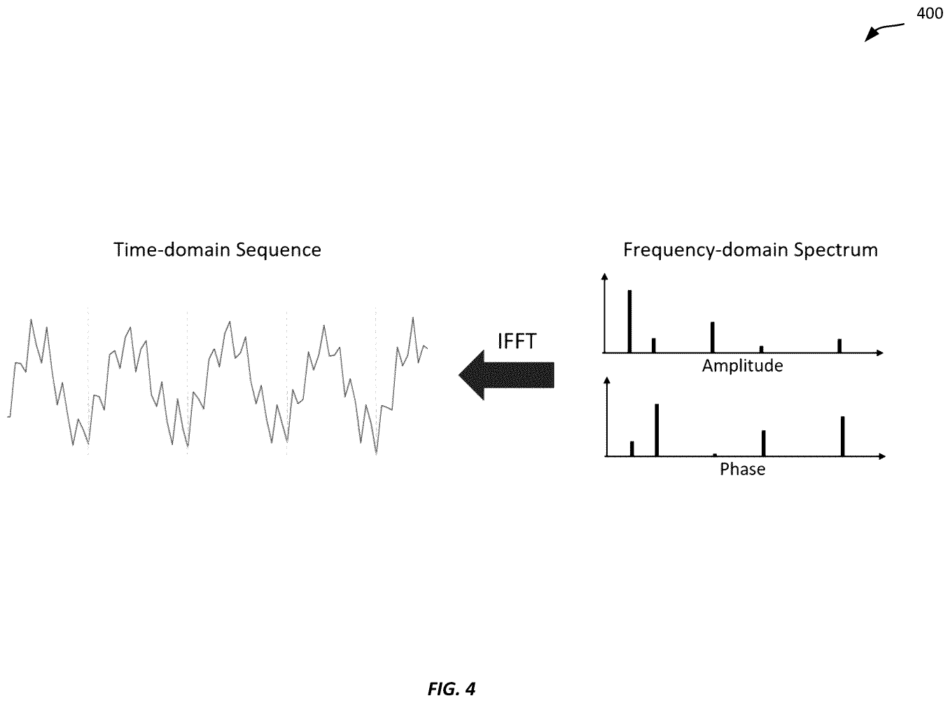

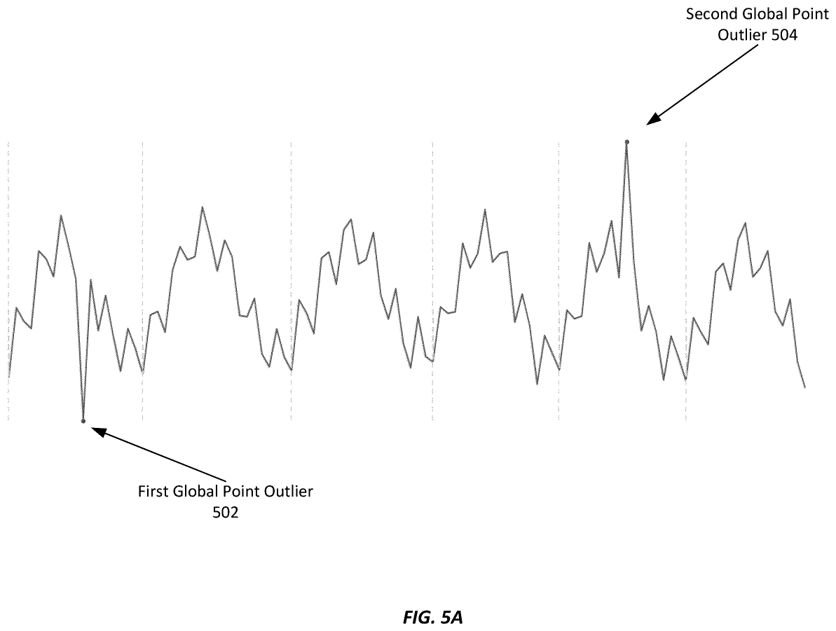

FIG. 4 illustrates an example of a transforming a frequency domain spectrum into a time domain spectrum, given numbers in the frequency domain spectrum and using an inverse discrete Fourier Transform (IFFT).

Illustration 400 shows that a frequency-domain spectrum may be converted into a time-domain sequence so that the change in a value over time may be visualized in a chart where time makes up the x-axis.

A frequency-domain spectrum may be transformed into a time-domain sequence using an inverse discrete Fourier transform. The inverse discrete Fourier transform is mathematically defined as:

$${X}_{k} = \frac{1}{N} {\sum }_{n = 0}^{N - 1} {x}_{n} \cdot {e}^{\frac{- i 2 π kn}{N}}$$

A time-domain sequence of the time series is obtained by using the discrete Fourier transform (IFFT). The time-domain sequence can convey a value (y-axis) based on a point in time (x-axis). For scale, in illustration 300, the vertical dashed lines of the time-domain sequence representation of the time series may represent a day-length period and points along the graphed line may represent recorded values for respective thirty-minute time intervals.

### IV. Types of Outliers

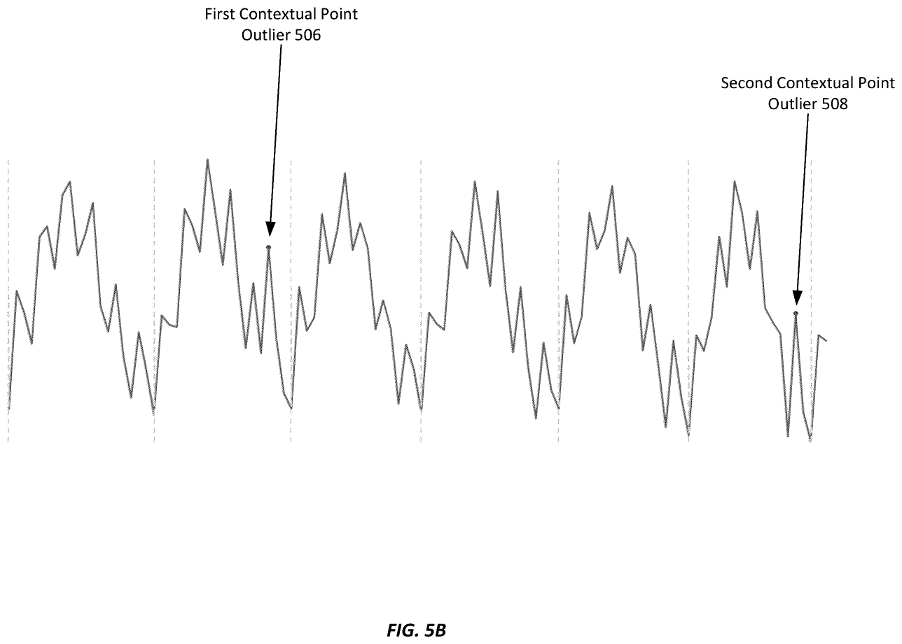

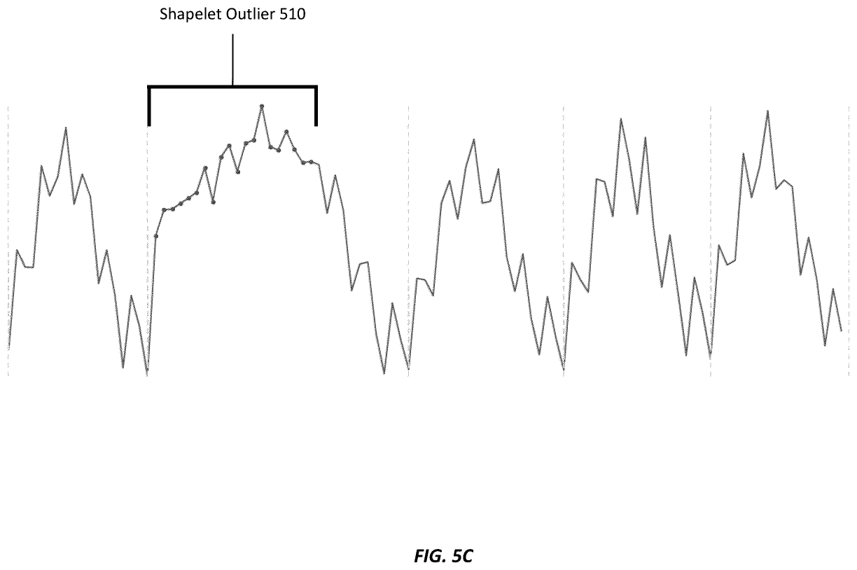

FIGS. 5A-5E illustrate examples of various types of outliers that may appear within a time series and therefore may be beneficial for a trained machine learning model to have the capability of correctly identifying. Such outliers may be observed in various sets of time series datapoints obtained through real-life observation. A time series may contain any number of outliers and any number of outlier types. Thus, it is possible that a time series may contain zero outlier points, one outlier, five outliers each having a different outlier type, five outliers of a single type and no other outliers, etc.

A non-exclusive list of outliers that may be included within a time series may be a global point outlier, contextual point outlier, shapelet outlier, seasonal outlier, and trend outlier.

### A. Global Point Outlier

FIG. 5A illustrates an example of a global point outlier. A global point outlier may be defined as a single point that is significantly larger or smaller than all other points in the time series that the outlier is included within. Thus, a single global point outlier includes a single anomalous point. To determine whether a point is significantly larger or smaller than all other points in a time series, a threshold may be used. As examples, a global outlier can be required to be 90% larger or 90% smaller than any other point in the time series, three times the value of the standard deviation of the whole time series, or another other threshold. A global point outlier is a global minimum (e.g., first global point outlier 502) or global maximum (e.g., second global point outlier 504).

As an example, the time domain representation illustrated in FIG. 5A may be representative of purchasing activity of a card, cardholder, merchant account (e.g., transaction count on the y-axis, transaction value on the y-axis), or business. Further the graph may relate to access requests to a resource. For example, anomalies may relate to cybersecurity for a networked computer, where such time series data relates to data read operations, data write operations, communications from/to a device, communications between devices, etc.

### B. Contextual Point Outlier

FIG. 5B illustrates an example of a contextual point outlier. A contextual point outlier may be defined as a single point significantly larger or smaller than other points within a local region. Thus, a single contextual point outlier includes a single anomalous point. To determine whether a point is significantly larger or smaller than other points within a local region of a time series, a threshold may be set (e.g., outlier is 90% larger or 90% smaller than any other point in the same local region of the time series).

A local region may be defined as a set of points within a given portion of a time series. Thus, each consecutive set of points in a time series may define a local region (e.g., points 1-100 are a first local region and points 101-200 are a second local region). In another embodiment, a point may be a contextual point outlier if it is larger or smaller than the nearest prior and subsequent portion of points (e.g., point 60 may be a local outlier compared to points 10-110). Thus, a local region size (how many points are included within the local region) can be defined based on a number of points or a percentage of the time series the points are included within. Further, a local region's scope (which points are included) may be local with respect to each point or with respect to a moving window the points are included within.

FIG. 5B illustrates an example of a first contextual point outlier 506 and a second contextual point outlier 508.

### C. Shapelet Outlier

FIG. 5C illustrates an example of a shapelet outlier. A shapelet may be defined as phase independent subsequences of a time series that are extracted from the time series to form discriminatory features, compared to other subsequences of the time series. Accordingly, a shapelet outlier represents those abnormal subsequences with significantly different properties compared to others in the time domain. A shapelet outlier may additionally be defined as a segment of points that form a significantly different shape from other points. Thus, a shapelet outlier includes more than one point, thereby creating a set of anomalous points that make up the shapelet outlier. A shapelet outlier may be detected based on a change in the amplitude and phase of a portion of a time series.

An example of a shapelet outlier is shapelet outlier 510 within the time series time domain representation in FIG. 5C. It can be seen the general shape of the time series line corresponding to shapelet outlier 510 seems lengthened compared to the corresponding more compressed looking shaped of other portion of the same time series.

### D. Seasonal Outlier

FIG. 5D illustrates an example of a seasonal outlier. A seasonal outlier may be defined as a segment of points that have the same shape as other sets of points but have a different wavelength (e.g., by at least a threshold value) than the other segment(s) of points. A segment of points that have the same shape as another set of points may be based on the point values between two points being the same values as between two other points. The wavelength of a wave may be defined as the distance between corresponding points (e.g., successive crests) in the adjacent cycle of a waveform signal in the time domain. Thus, a seasonal outlier includes more than one point, thereby creating a set of anomalous points that make up the seasonal outlier.

As an example, seasonal outlier 512 is illustrated as having a longer wavelength than other sets of points in the same time domain representation. Visually, the points included within the seasonal outlier 512 are spaced further apart along the x-axis of the wave than the corresponding points in the adjacent cycle of the wave. Therefore, the wavelength of the set of points of seasonal outlier 512 is different from the corresponding sets of points not within seasonal outlier 512.

### E. Trend Outlier

FIG. 5E illustrates an example of a trend outlier. A trend outlier may be defined as a segment of points that have an abnormal trend compared to other points in the time domain representation of points. A trend for a segment of points may be defined as the slope of the set of points. Additionally, an abnormal trend can be a trend that is different from one or more other segments of points in the time domain representation of points. In some cases, a trend outlier is different from other trends of time series segments by a threshold amount (e.g., slope is greater or less than the other trends of time series segments by a factor of two, five, 10, etc.). Thus, a trend outlier includes more than one point, thereby creating a set of anomalous points that make up the seasonal outlier.

Exemplary trend outlier 514 is illustrated as having an abnormal trend compared to other points in the time domain representation of points.

### V. Generating Noisy Training Data

Embodiments of the present disclosure can start with a base time series, add noise to the frequency domain, add noise to the time domain, and insert anomalies with corresponding labels. Thus, embodiments allow for complex time series data, including labeled anomalies and sufficient noise, to be generated for training a machine learning model.

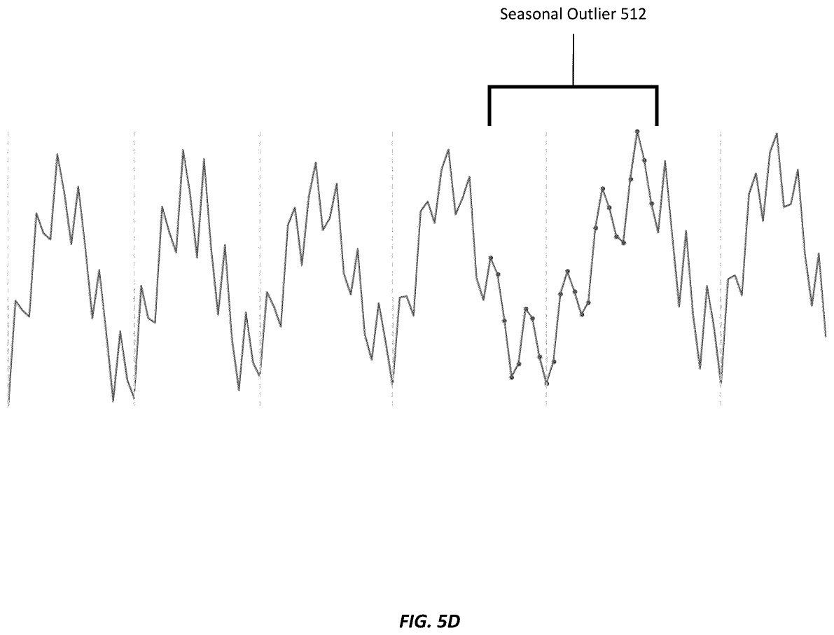

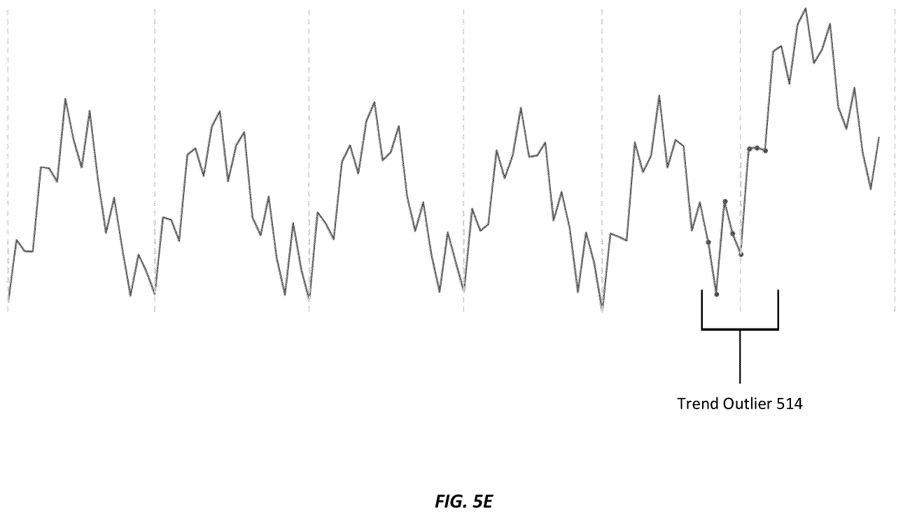

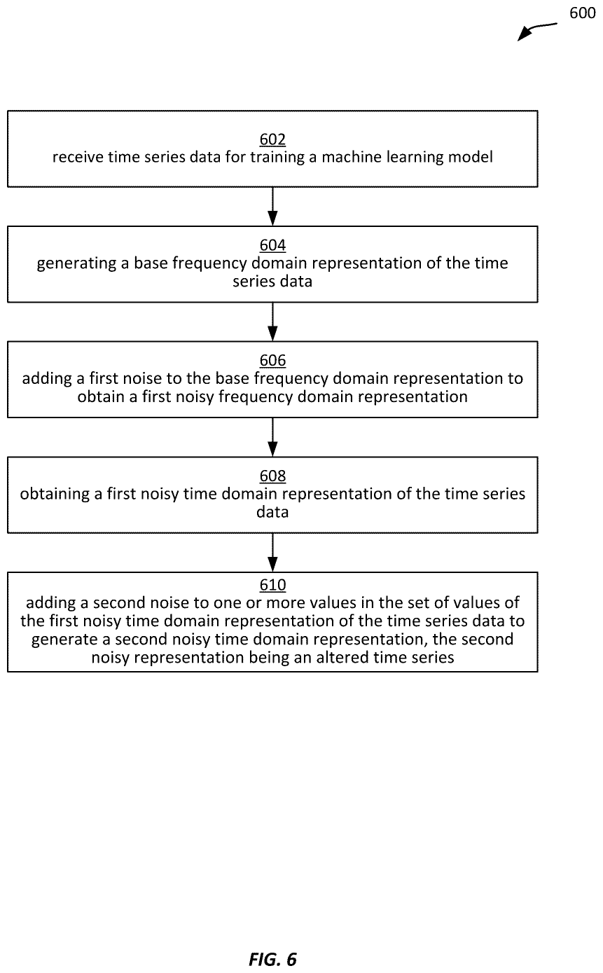

FIG. 6 illustrates a method for generating noisy training data according to an embodiment of the present disclosure. Method 600 is described in detail below and starts with receiving time series data.

### A. Receiving Time Series Data

At step 602, time series data for training a machine learning model is received. The time series data may be received by selecting a frequency domain representation of the time series data or by selecting a time domain representation of the time series data.

The frequency domain representation of the time series data may be received from time series data that was generated in the past (e.g., through collection of real data, generation of frequency domain representation data, generation of time domain representation data, and/or a combination thereof). In an embodiment, a frequency domain is generated by selecting a phase and amplitude, so that a time series is created based on the selection. The time series would therefore have a time domain representation that reflects the selection of the amplitude and the phase that was selected.

### B. Generating a Base Frequency Domain Representation

At step 604, using the received time series data, a base frequency domain of the time series data may be generated. Thus, in an embodiment, a frequency domain spectrum may be generated using a selected/predetermined, or random phase and amplitude, to thereby create a base frequency domain which may be used and altered to create noisy time series data.

In the frequency domain, the amplitude and the phase may be set randomly so that those two values can control the shape and/or the complexity of the generated time series. Differently shaped time series having different complexities and different frequencies may be generated by setting changing the phase and the amplitude.

In an embodiment, a time domain may be selected (e.g., from prior observed spatial time data, from a previous anomalous training data set) or generated (e.g., sinusoidal (sine) wave, square wave, triangular wave, sawtooth wave), before then being represented in the frequency domain to create a base frequency domain representation.

In an embodiment, prior observed time domain data may be obtained and modified to generate a base frequency domain representation. Thus, in an embodiment, a time window parameter may be set for collecting time domain time series datapoints (e.g., a time series of access requests, login attempts, transaction count, transaction amounts, etc.) of an observed time domain time series over the course of a time period (e.g., one week). The observed time domain time series may then be converted into the respective frequency domain and either used as a base frequency domain representation or one or more base parameters (e.g., phase and/or amplitude) of the frequency domain representation may be modified to thereby create a base frequency domain representation.

### C. Adding Noise to the Base Frequency Domain Representation

At step 606, a first noise may be added to the base frequency domain generated in step 604, to obtain a first noisy frequency domain representation.

Noises may be added to the base frequency domain representation to simulate the complex factors in the real world, making the time series represented by the base frequency domain more complex and realistic. Noise may be added to the base frequency domain representation by moving a value up or down randomly, in accordance with a distribution (e.g., uniform distribution, normal distribution, non-uniform distribution), or moved by a predetermined amount. Therefore, when adding noise in accordance with a distribution, the distribution may first be selected (e.g., a uniform distribution). The distribution may contain a range of number values (e.g., 0-1, 0-10, 0-100, 0-1000, (−1)-1, etc.) and the number values may appear within the distribution in accordance with the type of distribution. For example, in a uniform distribution, each number value will appear in the distribution as many times as each other number value. Once the distribution of number values is determined, one number value may be chosen at random. The number value that is chosen from the distribution at random may then be used to add noise to the value in the base frequency domain. For example, the randomly chosen number value may be added to, subtracted from, or multiplied with the value in the base frequency domain.

Each value within a frequency domain representation (e.g., the amplitude corresponding to a frequency, the phase corresponding to a frequency) may have noise added to it. In an embodiment, determining whether any given value within the set of values represented by the base frequency domain representation will have noise added to it is determined based on a distribution.

Further, the amount of which any given value of the base frequency domain representation may be moved up or down may also be predetermined or selected randomly, in accordance with a distribution. In an embodiment, the distribution used in determining which values are moved up or down and the distribution used in determining the extent that a value should be moved up or down are the same distribution. In an embodiment, a distribution is used in determining the extent that a value should be moved up or down, for each value in the frequency domain representation.

### D. Obtaining a Noisy Time Domain Representation

At step 608, a first noisy time domain representation of the time series data is obtained. The base frequency domain representation of the time series data can be transformed, using an inverse discrete Fourier transform, into the time domain representation of the time series data. Thus, as a result of the inverse discrete Fourier transformation, the first noisy time domain representation, which includes the added noise from step 606, is converted into a corresponding time domain representation.

In an embodiment, the obtained noisy time domain representation of the base frequency domain representation of the time series data may be referred to as a segment. A segment may be combined (e.g., appended) with one or more other segments to create a larger time series dataset. In an embodiment, when a first segment is combined with a copy of the first segment to create a time domain representation that has twice as many time points and a repeating pattern. In an embodiment, a first segment comprises a first noisy time domain representation of the time series data is obtained from a first base frequency domain representation and a second segment comprises a second noisy time domain representation of the time series data is obtained from a second base frequency domain representation. The second segment can then be appended to the first segment to create a time domain representation that is longer than either of the first or second segments and may include additional patterns.

### E. Adding Noise to Values in the Set of Values of the Noisy Time Domain Representation of the Time Series Data

At step 610, a second noise is added to one or more values in the set of values of the first noisy time domain representation of the time series data to generate a second noisy time domain representation, the second noisy time domain representation being an altered time series.

Noise may be added in a similar fashion that it was added to the base frequency domain representation to obtain a first noisy frequency domain representation in step 606. Thus, noise may be added to the first noisy time domain representation of the time series data to simulate the complex factors in the real world, making the time series represented by the base frequency domain more complex and realistic. Noise may be added to the first noisy time domain representation of the time series data by moving a y-axis value up or down by a predetermined amount or randomly, in accordance with a distribution (e.g., uniform distribution, normal distribution, non-uniform distribution). Therefore, when adding noise in accordance with a distribution, the distribution may first be selected (e.g., a uniform distribution). The distribution may contain a range of number values (e.g., 0-1, 0-10, 0-100, 0-1000, (−1)-1, etc.) and the number values may appear within the distribution in accordance with the type of distribution. For example, in a uniform distribution, each number value will appear in the distribution as many times as each other number value. Once the distribution of number values is determined, one number value may be chosen at random. The number value that is selected from the distribution at random may then be used to add noise to the y-axis value in the first noisy time domain representation. For example, the randomly selected number value may be added to, subtracted from, or multiplied with the y-axis value in the first noisy time domain representation.

Each value within a first noisy frequency domain representation (e.g., access request count, write operation count, read operation count, transaction amount, transaction frequency, messages sent, incoming communications count, available memory, etc.) may have noise added to it. In an embodiment, determining whether any given value within the set of values represented by the first noisy frequency domain representation will have noise added to it is determined based on a distribution.

Further, the amount of which any given value of the first noisy frequency domain representation may be moved up or down may also be predetermined or selected randomly, in accordance with a distribution. In an embodiment, the distribution used in determining which values are moved up or down and the distribution used in determining the extent that a value should be moved up or down are the same distribution. In an embodiment, a distribution is used in determining the extent that a value should be moved up or down, for each value in the first noisy frequency domain representation.

By adding a first noise to the frequency domain representation of the time series data and adding a second noise to the first noisy time domain representation of the time series data to generate a second noisy time domain representation, different time series patterns and/or different noise patterns may be introduced to the time series data and can make the time series data more random, complex, and/or realistic. In an embodiment, by adding noise in the frequency domain and the time domain, more complicated patterns may be generated compared to the pattern complexity that would otherwise be generated by adding noise to only in one domain or the other. Methods that synthesize time series data using the time domain by introducing noise only to the time domain representation of a time series result in time series data that is less complex and not as realistic.

In an embodiment, once the second noisy time domain representation is generated, it may be considered to be a segment, the segment may later be combined (e.g., appended) with one or more other segments (e.g., the same segment, the segment corresponding to the noisy time domain representation before further noise was added) to create a larger altered time series dataset. For example, if a first segment is generated and duplicated to generate a second segment, the two segments may be combined to create a time series dataset twice as large as the first segment.

In an embodiment, a segment corresponding to the noisy time domain representation before further noise was added may have an initial/first noise added to it, then the segment corresponding to the noisy time domain representation before further noise was added may have a different/second noise added to it, and the first and second noisy segments may be combined to create a larger altered series dataset made from two generated segments of noisy data.

After the altered time series is generated, in an embodiment, one or more values of the altered time series are replaced with one or more respective anomalous values. Such a process is described in more detail below.

### VI. Adding Anomalous Values

Anomalous values may be added to a time series dataset. Anomalies can be added into the time domain representation and/or in the frequency domain representation. As anomalies are added to a time series dataset, information relating to the anomalies may be recorded to create labels for the time series dataset, such labels can indicate where anomalies are within the time series dataset and what type of anomalies are at respective anomalous points. Further, the labeled time series dataset can be used to train a machine learning model to identify anomalies.

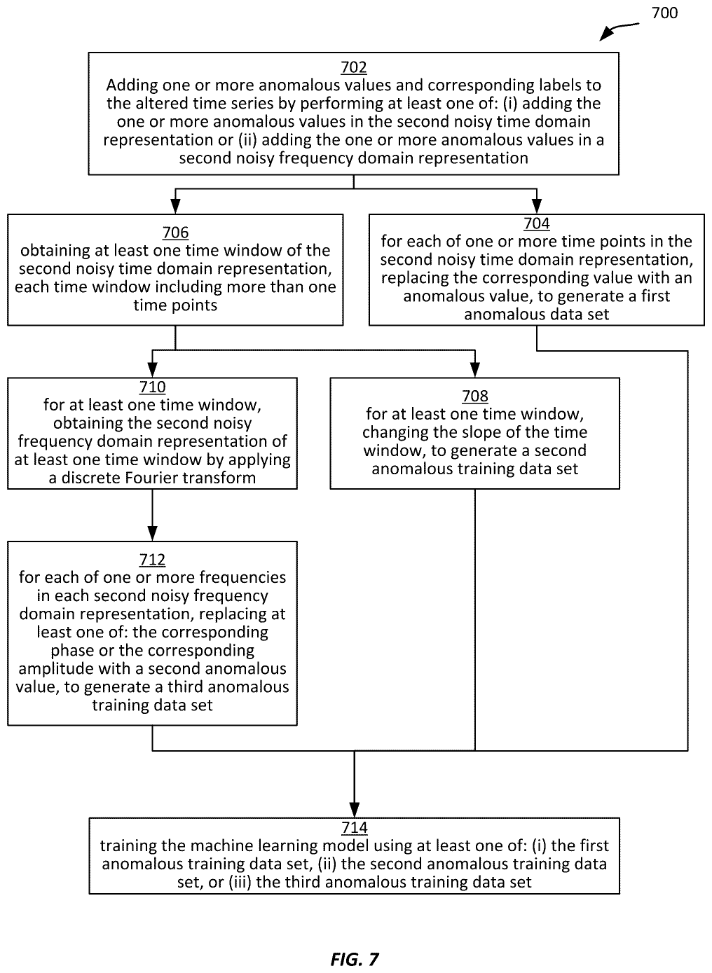

FIG. 7 illustrates a method for generating anomalous points and corresponding labels within a time series, according to an embodiment of the present disclosure.

After noise has been added to the frequency domain representation of the time series data and to the time domain of the time series data, to generate the altered time series data, anomalous values may be added by replacing one or more values of the altered time series with an anomalous value to generate an anomalous training dataset.

At step 702, anomalies may be added to at least one of: (i) the second noisy time domain representation or (ii) a second noisy frequency domain representation. Thus, anomalies may be added to at least one of: (i) the time domain representation of the altered time series data or (ii) the frequency domain representation of the altered time series data. Further, the added anomalies may be labeled to keep track of the position of the anomaly within the time series and the type of the anomaly at each corresponding position. Embodiments described herein allow for any number of anomalies and corresponding labels to be added to a time series.

Anomalies (also referred to as outliers) may be added to generate a diverse time series with one or more outliers and one or more different outlier types. By adding anomalies to a time series dataset such as the altered time series from method 600, a dataset with anomalies and noise may be created, which may be further used to train a machine learning model to identify anomalies within noisy datasets. Various types of anomalies (e.g., a global point outlier, a contextual point outlier, a shapelet outlier, a seasonal outlier, a trend outlier) may be added to time series data in the time domain and/or in the frequency domain.

### A. Adding Anomalous Values in a Spatial/Time Domain

At step 704, for each of one or more time points in the second noisy time domain representation, the corresponding value may be replaced with an anomalous value to generate a first anomalous dataset.

In the time domain representation, global point outliers and contextual point outliers may be added at step 704. Since time points of a time domain have a corresponding value that may be replaced with an anomalous value, embodiments can determine where to add anomalous values, and what each anomalous value should be, in various ways.

First, the number of anomalies (total anomalies or number of each respective type of anomaly) may be determined chosen based on a distribution (e.g., uniform distribution, non-uniform distribution). In an embodiment, parameters may be set to determine the distribution that is used to determine how many total anomalies will be inserted (e.g., based on a distribution, a specified count, or a specified range) and/or how many of each respective anomaly will be inserted.

Second, the time point of which may have a value changed to be anomalous could be chosen based on a distribution (e.g., uniform distribution, non-uniform distribution). In an embodiment, parameters may be set to determine the distribution that is used to determine where anomalies will be inserted or the positions where anomalies are going to be inserted may be predetermined (e.g., where an anomaly will be inserted at a desired time point of the time series is based on a set value).

Third, the type of anomaly added at a time point may also be predetermined or be chosen based on a distribution. In an embodiment, parameters may be set to determine the anomaly to be inserted or a set/predetermined value may be able to control which anomalies are inserted (and possibly where each type of anomaly is inserted)

Based on the mathematical properties of different outliers, different anomaly generation algorithms may be developed and used.

When inserting a global point anomaly, the value of the global point anomaly will be significantly larger or smaller among all time points of all other segments of the time series. Thus, in an embodiment, one way that a global point anomaly may be inserted is by comparing the standard deviation of the whole time series, and then multiplying the original value at a time-position by a value other than one (e.g., a value more than three times the amount of the standard deviation of the whole time series, a value). In an embodiment, a value greater than the standard deviation of the time series is added to or subtracted from a value of a time point of the time series to create a global minimum anomaly or a global maximum anomaly.

Thus, by changing a value of a time point in the time series to cause the value to be the largest or smallest value in a time series, a global point outlier may be created.

When inserting a contextual point anomaly, the value of the contextual anomaly will be significantly larger or smaller among all other time point in the same segment of the time series. In an embodiment, when changing a value of a time point to insert a contextual point anomaly, the average value of the time points within the same segment (e.g., 50 nearest time points (moving window), 50 time points within a segment that is otherwise defined (e.g., every 50 consecutive points comprises a segment)) is computed before modifying the original value of a time point within the segment.

In an embodiment, one way that a contextual point anomaly may be inserted is by comparing the standard deviation of the time points in the same segment as where the anomaly will be inserted, and then multiplying the original value at the time-position where the anomaly is being inserted by a value other than one (e.g., a value more than three times the amount of the standard deviation of the whole time series, a value). In an embodiment, a value greater than the standard deviation of the segment where an anomaly is being added is added to or subtracted from the value of a time point in the segment of the time series to create a contextual point anomaly.

Trend, seasonal, and shapelet outliers may be added after step 706. In step 706, a window of the time domain of the time series is obtained (e.g., the second noisy time domain representation). A window of the time domain includes more than one time point of the time domain spatial representation. The size of the time window (e.g., how many time points are be included in the time window) may be chosen based on a distribution, may be chosen based on a type of anomaly to be added into the time window, or may be a predetermined size (e.g., determined by a set value). Further, the number of time windows selected from time domain representation may be determined based on a distribution or may be a predetermined count. Additionally, in an embodiment, the starting point of a time window may be chosen based on a distribution, may be chosen based on a type of anomaly to be added into the time window, or may be a predetermined time point. In an embodiment, the distributions used may correspond to observed distributions of anomalies in other datasets.

Once a window of the time domain has been obtained, a trend, seasonal, or shapelet outlier may be added. A trend outlier can be added to the time series using the time domain representation of the time series. Seasonal and shapelet outliers can be added to the time series using the frequency domain representation of the time series.

When inserting a tend anomaly, the window of the time domain (e.g., the second noisy time domain representation) of the time series obtained in step 706 is used, the slope measured, the slope changed, and the window inserted back into the time domain with the anomalous data.

At step 708, a trend anomaly may be generated and inserted into the time series. In an embodiment, the trend anomaly may be generated by computing the slope, in the time domain, of the time series window and then changing the slope of the time series window. By changing the slope of the time series datapoints within the window, the trend of the time series within the time series window changes. The amount of which the slope is either increased or decreased may be determined based on a distribution or may be predetermined (e.g., chosen by a set value). In an embodiment, changing the value of any given point in the time window is based on the slope the time window is being changed to and where the time point is within the time window. The anomalous time window may then be re-inserted back into the window of the time series where it was taken from.

As the anomalies are added to the time series, a time point data label is associated with the time point to keep track of the anomaly position and the anomaly type.

As mentioned above, seasonal and shapelet outliers can be added to the time series using the frequency domain representation of the time series.

### B. Adding Anomalous Values in a Frequency Domain

To add anomalous values in the frequency domain, the frequency domain must first be obtained.

At step 710, a second noisy frequency domain representation of a time window may be obtained by applying a discrete Fourier transform to the portion of the time domain that is represented by the time window.

At step 712, anomalies may be inserted into the time series. At step 712, for each of the one or more frequencies in each second noisy frequency domain representation, at least one of the following is replaced with an anomalous value: (i) the corresponding phase or (ii) the corresponding amplitude. Once at least one of the phase or amplitude have had their respective value replaced, labels may be created for the corresponding time series points to track which time points the corresponding anomaly has been inserted into and the type of anomaly that was inserted. In an embodiment, determining whether to insert a seasonal or shapelet anomaly may be based on a distribution or may be predetermined.

In an embodiment, a seasonal anomaly may be generated by changing the phase value of one or more frequencies of the second noisy frequency domain which corresponds to the selected time window. In an embodiment, the change in the phase value is small, on average, but may have a chance of being larger. Determining which phase value(s) to change may also be determined based on a distribution or may be predetermined. By changing the phase of a time series, the length of the corresponding time domain period changes.

The second noisy frequency domain, now having at least one altered phase value, may then be converted back into the time domain representation of the time series window, the time series window now also having anomalous values and thereby creating an anomalous window. The anomalous window can then be inserted back into the time domain of the altered time series.

In some embodiments, when an anomalous window is being inserted back into the altered time series, a gap may be created between the ends of the time points within the anomalous window and the time points at the ends of the anomalous window. In such cases, in an embodiment, the same phase value(s) may be changed again to reduce the gap distance. In an embodiment, a line may be inserted between points with a gap between them to allow them to connect and create a continuous time domain representation of the time series. In an embodiment, the point(s) near the end(s) of the time window may be smoothed out according to boundary conditions to help reduce the gap.

In an embodiment, a shapelet anomaly may be generated by changing the phase value and the amplitude value of one or more frequencies of the second noisy frequency domain that corresponds to the selected time window. In some embodiments, such a change in the frequency domain may cause the length and shape of a portion of corresponding portion of the time series in the time domain to be changed and/or lengthened.

The second noisy frequency domain, now having at least one altered phase value and one altered amplitude value, may then be converted back into the time domain representation of the time series window, the time series window now also having anomalous values and thereby creating an anomalous window. The anomalous window can then be inserted back into the time domain of the altered time series where the original window was.

### C. Training a Machine Learning Model

As mentioned above, as anomalies are inserted in the time domain and/or the frequency domain, corresponding labels are created for the time series that identify at which points in the time series data the anomalies exist and what type of anomalies exist at respective points.

At step 714, a machine learning model may be trained given the time series data that has been generated by adding noise in the frequency domain, adding noise in the time domain, and had one or more anomalous values added to it (in the time domain and/or in the frequency domain).

Anomalous events the model may be trained to detect may be access requests, anomalous purchasing activity of a card, cardholder, merchant account, or business. Further anomalies may relate to cybersecurity, such as data read operations, data write operations, communications to/from a device, communications between devices, etc.

Although outlier detection is mentioned throughout, the training of a model could also be to detect other abnormal observations or malicious behaviors in a time series (e.g., by taking into account other criteria and/or data to make a classification regarding whether observed behavior is anomalous).

### VII. Method of Training a Model Using Simulated Noise Data

The above-described methods (method 600 and method 700) may be combined to generate noisy data and add anomalous points to the data with corresponding labels to generate a noisy and anomalous training dataset which may then be used to train a machine learning model.

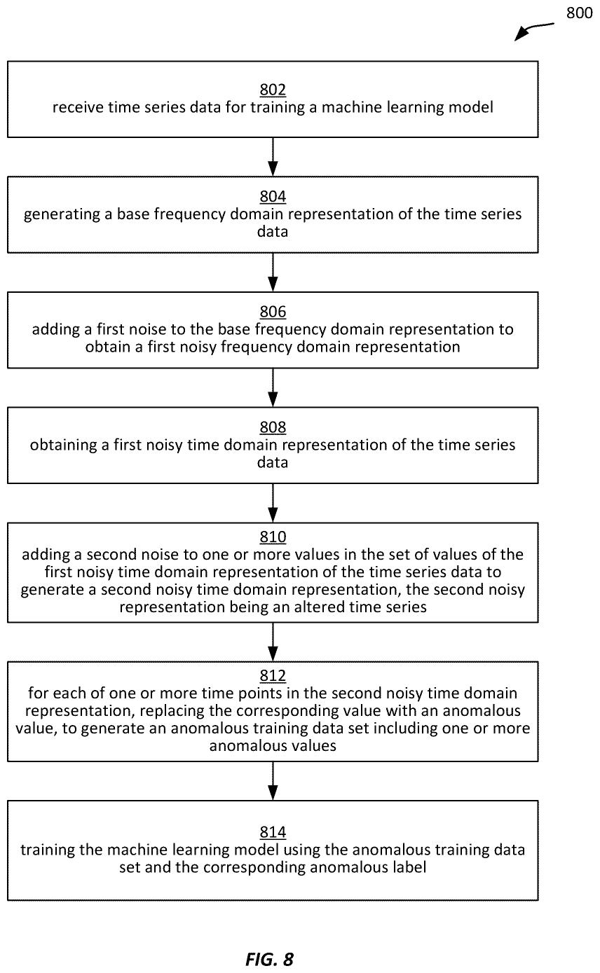

FIG. 8 illustrates a method for generating noisy data, anomalous points, and corresponding labels within a time series to create a noisy and anomalous training dataset, according to an embodiment of the present disclosure. The steps of method 800 can be performed in a similar manner described in with respect to method 600 and method 700.

At step 802, time series data for training a machine learning model is received. Step 802 can be performed in a similar manner as step 602.

At step 804, a base frequency domain representation of the time series data is generated. Step 804 can be performed in a similar manner as step 604.

At step 806, a first noise is added to the base frequency domain representation to obtain a first noisy frequency domain representation. Step 806 can be performed in a similar manner as step 606.

At step 808, a first noisy time domain representation of the time series data is obtained by applying an inverse discrete Fourier transform to the first noisy frequency domain representation. The first noisy time domain representation may include a set of values for a set of time points. Each value in the set of values may correspond to a time point in the set of time points. Thus, in an embodiment, each value corresponds to one time point and the time points has one value. Step 808 can be performed in a similar manner as step 608.

At step 810, adding a second noise to one or more values in the set of values of the first noisy time domain representation of the time series data to generate a second noisy time domain representation. Step 810 can be performed in a similar manner as step 610.

At step 812, for each of one or more time points in the second noisy time domain representation, the corresponding value is replaced with an anomalous value, to generate an anomalous training data set including one or more anomalous values. Replacing the corresponding value with an anomalous value can include adding anomalous values within the time domain and/or the frequency domain because changes in either of the domains cause a change in a value of the time domain representation of the time series data. Additionally, the anomalous training data set may have a corresponding anomalous label for a time period including the one or more anomalous values. Step 812 can be performed in a similar manner as steps 702-712.

At step 814, the machine learning model is trained using the anomalous training data set and the corresponding anomalous label. Once the machine learning model has been trained, the machine learning model may be used to identify anomalies within a time series. Step 814 can be performed in a similar manner as step 714.

### VIII. Example Generated Data

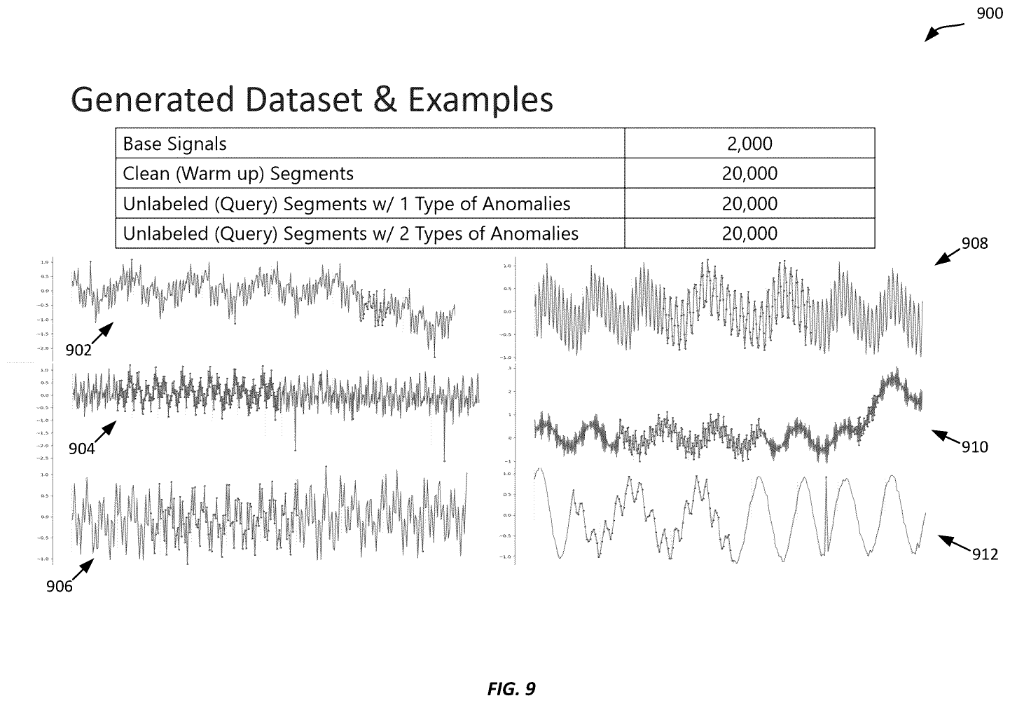

FIG. 9 illustrates an example of datasets created using an embodiment of the present disclosure.

Six datasets are shown in illustration 900 and the ability to produce complex datasets with various anomalies is displayed. The noisy base signals may be generated by adding noise to the frequency domain and the time domain of the base signal (e.g., sine wave) so that anomalies may then be added to the base signal in a way that allows for the creation of complex datasets and where the complex datasets may be labeled.

Dataset 902 is an example complex dataset that was generated using embodiments described herein, dataset 902 includes contextual and trend anomalies.

Dataset 904 is an example complex dataset that was generated using embodiments described herein, dataset 904 includes seasonal and global anomalies.

Dataset 906 is an example complex dataset that was generated using embodiments described herein, dataset 906 includes shapelet and contextual anomalies.

Dataset 908 is an example complex dataset that was generated using embodiments described herein, dataset 908 includes a seasonal anomaly.

Dataset 910 is an example complex dataset that was generated using embodiments described herein, dataset 910 includes seasonal and trend anomalies.

Dataset 912 is an example complex dataset that was generated using embodiments described herein, dataset 912 includes shapelet and global anomalies.

### IX. Computer System

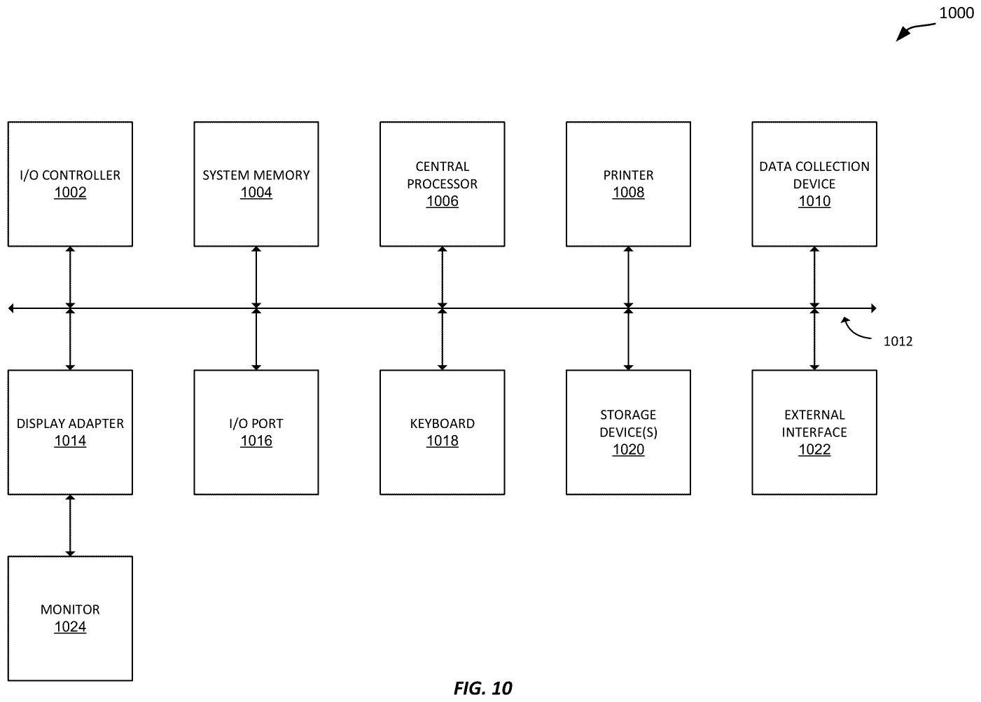

Any of the computer systems mentioned herein may utilize any suitable number of subsystems. Examples of such subsystems are shown in FIG. 10 in computer system 1000. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 10 are interconnected via a system bus 1012. Additional subsystems such as a printer 1008, keyboard 1018, storage device(s) 1020, monitor 1024 (e.g., a display screen, such as an LED), which is coupled to display adapter 1014, and others are shown. Peripherals and input/output (I/O) devices, which couple to I/O controller 1002, can be connected to the computer system by any number of means known in the art such as input/output (I/O) port 1016 (e.g., USB, FireWire®). For example, I/O port 1016 or external interface 1022 (e.g., Ethernet, Wi-Fi, etc.) can be used to connect computer system 1000 to a wide area network such as the Internet, a mouse input device, or a scanner. The interconnection via system bus 1012 allows the central processor 1006 to communicate with each subsystem and to control the execution of a plurality of instructions from system memory 1004 or the storage device(s) 1020 (e.g., a fixed disk, such as a hard drive, or optical disk), as well as the exchange of information between subsystems. The system memory 1004 and/or the storage device(s) 1020 may embody a computer readable medium. Another subsystem is a data collection device 1010, such as a camera, microphone, accelerometer, and the like. Any of the data mentioned herein can be output from one component to another component and/or can be output to a user.

A computer system can include a plurality of the same components or subsystems, e.g., connected together by external interface 1022, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components. In various embodiments, methods may involve various numbers of clients and/or servers, including at least 10, 20, 50, 100, 200, 500, 1,000, or 10,000 devices. Methods can include various numbers of communication messages between devices, including at least 100, 200, 500, 1,000, 10,000, 50,000, 100,000, 500,00, or one million communication messages. Such communications can involve at least 1 MB, 10 MB, 100 MB, 1 GB, 10 GB, or 100 GB of data.

Any of the computer systems mentioned herein may utilize any suitable number of subsystems. In some embodiments, a computer system includes a single computer apparatus, where the subsystems can be components of the computer apparatus. In other embodiments, a computer system can include multiple computer apparatuses, each being a subsystem, with internal components.

A computer system can include a plurality of the components or subsystems, e.g., connected together by external interface or by an internal interface. In some embodiments, computer systems, subsystems, or apparatuses can communicate over a network. In such instances, one computer can be considered a client and another computer a server, where each can be part of a same computer system. A client and a server can each include multiple systems, subsystems, or components.

It should be understood that any of the embodiments of the present disclosure can be implemented in the form of control logic using hardware (e.g., an application specific integrated circuit or field programmable gate array) and/or using computer software with a generally programmable processor in a modular or integrated manner. As used herein a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present disclosure may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Any operations performed with a processor may be performed in real-time. The term “real-time” may refer to computing operations or processes that are completed within a certain time constraint. The time constraint may be 1 minute, 1 hour, 1 day, or 7 days. Thus, embodiments involve computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, and of the steps of any of the methods can be performed with modules, circuits, or other means for performing these steps.

The specific details of particular embodiments may be combined in any suitable manner without departing from the spirit and scope of embodiments of the disclosure. However, other embodiments of the disclosure may involve specific embodiments relating to each individual aspect, or specific combinations of these individual aspects. The above description of exemplary embodiments of the disclosure has been presented for the purpose of illustration and description. It is not intended to be exhaustive or to limit the disclosure to the precise form described, and many modifications and variations are possible in light of the teaching above. The embodiments were chosen and described in order to best explain the principles of the disclosure and its practical applications to thereby enable others skilled in the art to best utilize the disclosure in various embodiments and with various modifications as are suited to the particular use contemplated.

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

One or more features from any embodiment may be combined with one or more features of any other embodiment without departing from the scope of the disclosure.

A recitation of “a”, “an” or “the” is intended to mean “one or more” unless specifically indicated to the contrary. The use of “or” is intended to mean an “inclusive or,” and not an “exclusive or” unless specifically indicated to the contrary.

All patents, patent applications, publications, and descriptions mentioned above are herein incorporated by reference in their entirety for all purposes. None is admitted to be prior art.

What is claimed is:

1. A method of training a machine learning model, the method comprising:
receiving time series data for training the machine learning model;
generating a base frequency domain representation of the time series data;
adding a first noise to the base frequency domain representation to obtain a first noisy frequency domain representation;
obtaining a first noisy time domain representation of the time series data by applying an inverse discrete Fourier transform to the first noisy frequency domain representation, the first noisy time domain representation including a set of values for a set of time points, wherein each value in the set of values corresponds to a time point in the set of time points;
adding a second noise to one or more values in the set of values of the first noisy time domain representation of the time series data to generate a second noisy time domain representation;
for each of one or more time points in the second noisy time domain representation, replacing the corresponding value with an anomalous value to generate an anomalous training data set including one or more anomalous values, the anomalous training data set having a corresponding anomalous label for a time period including the one or more anomalous values; and
training the machine learning model using the anomalous training data set and the corresponding anomalous label.

2. The method of claim 1, wherein adding the first noise to the base frequency domain representation to obtain the first noisy frequency domain representation further comprises:
for each of one or more frequencies in the base frequency domain representation, increasing or decreasing at least one of: a corresponding phase value or a corresponding amplitude value by a random amount.

3. The method of claim 1, wherein the corresponding anomalous label indicate at least one anomaly type of: a global point anomaly, a contextual point anomaly, a shapelet anomaly, a seasonal anomaly, or a trend anomaly.

4. The method of claim 3, wherein the anomaly type is determined based on at least one of: (i) a predetermined anomaly type selected randomly from a distribution or (ii) a predefined anomaly insertion type.

5. The method of claim 1, wherein replacing the corresponding value with the anomalous value comprises:
obtaining a second noisy frequency domain representation of the time series data by applying a discrete Fourier transform to the second noisy time domain representation, the second noisy frequency domain representation including a corresponding phase and corresponding amplitude for each frequency; and
for each of one or more frequencies in the second noisy frequency domain representation, replacing at least one of: the corresponding phase or the corresponding amplitude with a second anomalous value.

6. The method of claim 1, wherein the one or more values in the set of values of the first noisy time domain representation are determined based on a position of the one or more corresponding time points, and wherein the position is selected randomly from a distribution.

7. The method of claim 1, wherein a number of anomalous values in the anomalous training data set: (i) is within a specified range or (ii) results from a probabilistic determination as to whether each of a second set of time points in the second noisy time domain representation are to be anomalous.

8. The method of claim 1, further comprising:
replacing one or more adjoining values of one or more adjoining time points with one or more second anomalous values, wherein a number of the one or more adjoining time points is predetermined or selected randomly from a distribution.

9. The method of claim 1, wherein the anomalous value is chosen from a range of possible values, each respective possible value being selected randomly from a distribution.

10. The method of claim 1, wherein the anomalous training data set represents access requests to a resource, and wherein the machine learning model is trained to identify anomalous access requests to access the resource.

11. The method of claim 1, further comprising:
generating additional anomalous training data sets, each having one or more anomalous labels for corresponding time period(s), wherein the additional anomalous training data sets are used to train the machine learning model.

12. A system for training a machine learning model, the system comprising:
one or more storage media configured to store computer-executable instructions; and
one or more processors configured to access the one or more storage media and execute the computer-executable instructions to at least:
receive time series data for training the machine learning model;
generating a base frequency domain representation of the time series data;
adding a first noise to the base frequency domain representation to obtain a first noisy frequency domain representation;
obtain a first noisy time domain representation of the time series data by applying an inverse discrete Fourier transform to the first noisy frequency domain representation, the first noisy time domain representation including a set of values for a set of time points, wherein each value in the set of values corresponds to a time point in the set of time points;
add a second noise to one or more values in the set of values of the first noisy time domain representation of the time series data to generate a second noisy time domain representation;
for each of one or more time points in the second noisy time domain representation, replace the corresponding value with an anomalous value to generate an anomalous training data set including one or more anomalous values, the anomalous training data set having a corresponding anomalous label for a time period including the one or more anomalous values; and
train the machine learning model using the anomalous training data set and the corresponding anomalous label.

13. The system of claim 12, wherein adding the first noise to the base frequency domain representation to obtain the first noisy frequency domain representation further comprises:
for each of one or more frequencies in the base frequency domain representation, increasing or decreasing at least one of: a corresponding phase value or a corresponding amplitude value by a random amount.

14. The system of claim 12, wherein the corresponding anomalous label indicate at least one anomaly type of: a global point anomaly, a contextual point anomaly, a shapelet anomaly, a seasonal anomaly, or a trend anomaly.

15. The system of claim 14, wherein the anomaly type is determined based on at least one of: (i) a predetermined anomaly type selected randomly from a distribution or (ii) a predefined anomaly insertion type.

16. The system of claim 12, wherein replacing the corresponding value with the anomalous value comprises:
obtaining a second noisy frequency domain representation of the time series data by applying a discrete Fourier transform to the second noisy time domain representation, the second noisy frequency domain representation including a corresponding phase and corresponding amplitude for each frequency; and
for each of one or more frequencies in the second noisy frequency domain representation, replacing at least one of: the corresponding phase or the corresponding amplitude with a second anomalous value.

17. The system of claim 12, wherein the one or more values in the set of values of the first noisy time domain representation are determined based on a position of the one or more corresponding time points, and wherein the position is selected randomly from a distribution.

18. The system of claim 12, wherein a number of anomalous values in the anomalous training data set: (i) is within a specified range or (ii) results from a probabilistic determination as to whether each of a second set of time points in the second noisy time domain representation are to be anomalous.

19. The system of claim 12, wherein the computer-executable instructions are further configured to at least:
replace one or more adjoining values of one or more adjoining time points with one or more second anomalous values, wherein a number of the one or more adjoining time points is predetermined or selected randomly from a distribution.

20. The system of claim 12, wherein the anomalous value is chosen from a range of possible values, each respective possible value being selected randomly from a distribution.
